(19) United States
(12) Patent Application Publication
(10) Pub. No.: US 2003/0072352 A1
(43) Pub. Date: Apr. 17, 2003

(54) Temperature sensor with a sensor element and use thereof

(75) Inventor: Matthias Muziol, SeligenstadtHSN-TG (DE)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Heraeus Sensor-Nite GmbH

(21) Appl. No.: 10/272,131

(22) Filed: Oct. 15, 2002

(30) Foreign Application Priority Data
Oct. 15, 2001 (DE) 101 50 332.6
Dec. 21, 2001 (DE) 101 63 549.4

(51) Int. Cl. G01K 1/00

(52) U.S. Cl. 374/208

(57) ABSTRACT

A temperature sensor for temperature measurement in the gap between ceramic hot plates and radiant heating elements has at least one sensor element (3), which is at least partially enclosed by a trough-shaped protective housing (1) made of heat-resistant ceramic. The sensor element (3) provided with electrical connection lines is arranged in the region of one end or at the tip of the protective housing (1), while the electrical connection lines (4) are guided out through the other end of the protective housing. A temperature-dependent electrical measuring resistor with a resistive layer is used as the sensor element (3), wherein the resistive layer has at least one metal from the platinum metal group. The measuring resistor is fixed in the end region (20) of the protective housing (1) using a ceramic grout or is secured against falling out by capping it with a mica cover (7). At the other end of the protective housing the electrical connection lines (4) are constructed as plug contacts.

### BACKGROUND OF THE INVENTION

The invention relates to a temperature sensor having at least one sensor element which is at least partially enclosed by a protective housing made of a heat resistant ceramic, wherein the sensor element, which is provided with connection lines, is arranged in the region of one end of the protective housing, while the connection lines are guided out through the other end of the protective housing. The invention also relates to a method of using the temperature sensor.

From German published patent application DE 27 38 926 A1 a protective tube is known for a thermal element used for continuous measurement of the temperature of molten steel, in which an inner ceramic tube with a closed end, which contains the thermocouple, is further sealed from the outside by means of an exterior quartz tube arranged over the inner ceramic tube, whereby an annular space is formed between the two tubes arranged concentric with respect to one another. This space is insulated by a thermally insulating intermediate layer formed inside the annular space. For this purpose, the inner ceramic tube is preferably made of aluminum oxide, beryllium oxide and/or magnesium oxide. However, it is also possible to use metal carbide as the material for the inner ceramic tube.

Because of its relatively high thermal stability up to temperatures of 2000° C., the construction of the protective tube has proven to be relatively expensive, such that it may hardly be usable in household devices, for example, where a favorable price structure is usually necessary.

Furthermore, an electric radiant heating element is known from European patent EP 0 288 915 B2 for heating a plate, in particular a glass-ceramic hot plate, in which electric heating resistors are arranged on an insulator body spaced from the plate, and in which a rod-shaped temperature sensor of a thermostat projects between the insulator and the plate in the central region over the heating zone of the radiant heating element. At least one cam-shaped spacer with a limited extension in the longitudinal direction of the temperature sensor and associated therewith in the central region of the heating zone is provided for maintaining a minimum spacing between the insulator or the resistors arranged thereon and the temperature sensor or the plate, and for preventing an upward curvature of the insulator and for stiffening the radiant heating element. The spacer is arranged in the unheated area of the heating zone and is formed as an upwardly directed projection of the insulator in one piece with the insulator, wherein the temperature sensor formed with a metallic outer tube is mounted substantially rigidly at each end and is fixed relatively firmly at a switch head of the thermostat.

### BRIEF SUMMARY OF THE INVENTION

An object of the invention is to perform a temperature measurement in radiant heating elements, as is done underneath Ceran™ cooktops, wherein the commonly used electromechanical solid expansion switch is to be replaced by a resistance temperature sensor. The temperature range to be measured should lie between −40 to +750° C. Furthermore, a relatively simple cable connection via flat plugs should result, wherein the fastening of the temperature sensor should be extremely cost-effective.

This object is met according to the invention in that a temperature-dependent electrical measuring resistor with a resistance layer is provided as a sensor element, the layer having at least one metal from the platinum metals group.

An essential feature of the invention can be seen in that the connection lines, which are guided outside through the other end of the protective housing, are constructed as plug contacts.

In an advantageous embodiment of the invention, the heat resistant ceramic of the protective housing contains corderite. However, it is also possible to use steatite as the heat resistant ceramic for the protective housing. The protective housing is provided with a connection block to connect the terminal lines to terminal contacts.

Advantageously, the measuring resistor, as the sensor element, is fixed in the end region of the protective housing using ceramic grout. However, it is also possible to cap off the measuring resistor, as the sensor element, in the receiving end region of the protective housing using a housing cover. Moreover, the sensor element can be fixed both by grout and by a housing cover.

The protective housing can involve an extended, upwardly open housing, which is advantageously covered with a cover.

Here, the temperature sensor is used for forming a control parameter in a control circuit, which has at least one radiant heating element that acts thermally on the temperature sensor.

Advantageously, the temperature sensor is used as a resistance thermometer in the region between a radiant heating element and a hot plate, in particular a glass-ceramic hot plate of an electric range.

It has proven advantageous that the ceramic, as a protective housing or protective tube, is no longer oxidized and thus does not become blackened, such as occurs with a metallic protective tube, for example. The thermal coupling thereby remains constant.

The ceramic, as a protective housing or as a protective tube, serves at the same time as an insulator and therefore does not reduce the insulation gap to be maintained between the glass-ceramic plate and the heating element coils. The result is a clear set of process steps, such as insert, bend and rotate, whereby an easy assembly or a simple automation of the assembly is provided. The main direction of installation is vertical.

Another advantage is seen in the relatively small number of components. Multiple functions are integrated into a single component. Thus, the housing serves as a protective tube, as a connection block, and for conductor insulation. Advantageously, the flange positions the housing and fastens the mica cover.

The temperature sensor according to the invention is used primarily for the temperature measurement of a radiant heating element, wherein the maximum temperature to be used is 750° C. Furthermore, it is conceivable to monitor flames or to monitor exhaust ovens or even hot air systems.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIGS. 1a and 1b are side sectional views of a temperature sensor in a metal pan of an electric range, the metal pan serving as the housing for the heating element, wherein the sensor with a ceramic housing enclosing it is guided through a side wall of the metal pan. According to FIG. 1b the sensor is fastened to the metal pan by a separate metal flange. In FIG. 1a the metal flange is not needed. The metal pan has a notch for accommodating the ceramic housing.

FIGS. 2a and 2b are top views of pan (broken away) and the ceramic housing according to FIGS. 1a and 1b, respectively, with the temperature sensor, wherein the housing integrates the connection block, the protective tube and the insulator into one unit.

FIGS. 3a and 3b are end views of the arrangement in FIGS. 1a and 1b, respectively, with the pan (broken away) or flange and a cross section through the ceramic housing, wherein the electric conductors to the measuring element can be recognized.

FIGS. 4a and 4b are end views of the arrangements shown in FIGS. 1a and 1b, respectively, showing the downwardly bent terminal contacts, wherein retaining tabs secure them against sliding through.

FIG. 5 is a plan view of the unbent electric conductor together with the retaining tabs to prevent sliding and with the terminal contact, wherein the bend line can also be seen.

FIGS. 6a and 6b are end and side sectional views, respectively, of the metal flange together with metal lugs, wherein FIG. 6a correspond to a side view similar to FIG. 3a, while FIG. 6b shows a longitudinal section rotated by 90°.

FIG. 6c is a top view of the metal flange alone, corresponding to the side view of FIG. 1b.

### DETAILED DESCRIPTION OF THE INVENTION

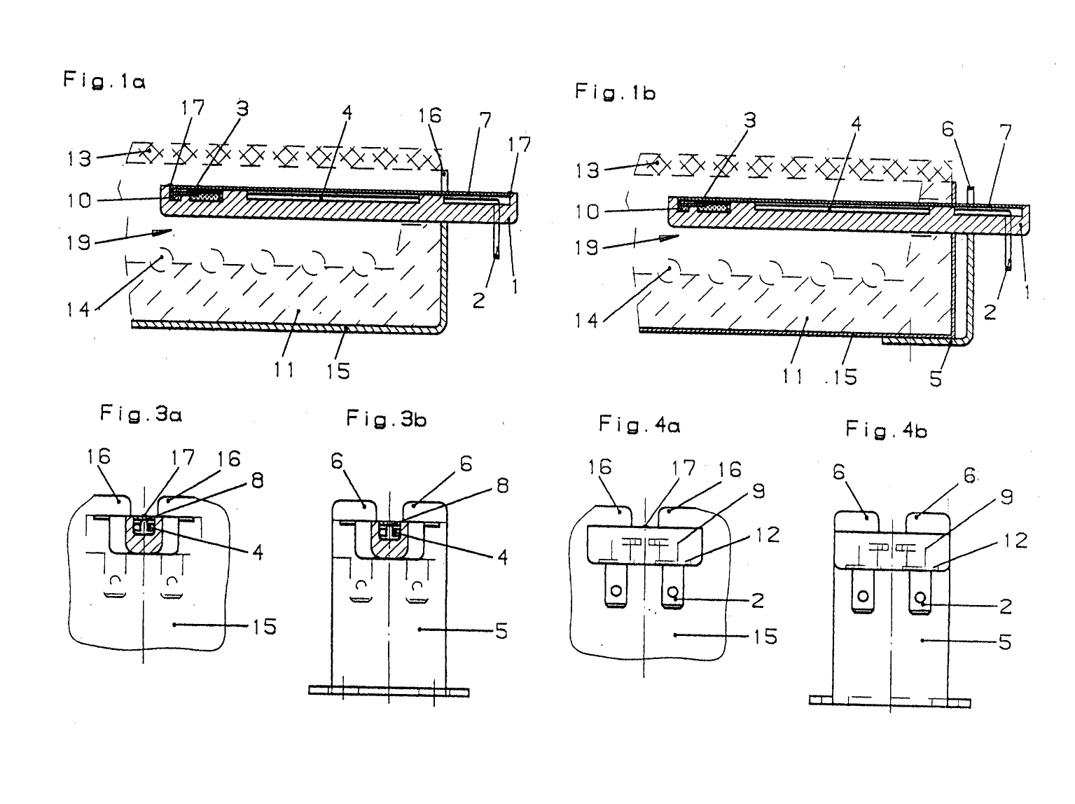

According to FIG. 1a a trough-shaped ceramic housing is provided as a protective housing 1 for a sensor element 3, wherein the protective housing 1 extends through the side wall of a radiant heating element housing 15, constructed as a metal pan, into the interior 19 between the radiant heating element 11 and a glass-ceramic plate 13 that serves as an outer cover. The protective housing 1, which is closed by means of a cover 7, contains the sensor element 3 for temperature measurement located in the region of its measurement tip as the end area 20 directed toward the interior 19. The sensor element is connected to the electric conductors 4 (only partially recognizable), which are arranged within the protective tube-shaped part of the protective housing 1, by means of terminal conductors, not recognizable here. The sensor element 3 is fixed in the region of the end 20 of the protective housing 1 using ceramic grout 10. An embodiment without grout 10 is also possible, wherein the end region 20, which is constructed hollow, is capped using a cover made of mica 7, so that the sensor element cannot fall out. Moreover, it is possible to protect against contact a sensor element 3 already fixed using grout 10 by installing a cover made of mica 7.

On the side opposite the end (tip) 20 of the protective housing 1, the housing has two slots for terminal contacts, which are fixed by bending them back or turning them along a bend line, which will become clear later with the aid of FIGS. 4a and 4b.

The heat-resistant ceramic of the protective housing 1 is preferably made of corderite or steatite. So that the mica cover 7 does not get lost prior to the installation the bending of the metal lugs 16, it is secured to the housing using grout or adhesive 17.

In FIG. 1b a variation of FIG. 1a is shown, wherein an additional metal flange 5, bent perpendicularly upward, is provided to improve the stability in the region of the terminal contact 2. This obviates the need to fix the cover 7 using grout, since the lugs 6 hold the cover in the housing.

In FIGS. 1a and 1b the heating element windings 14 of the radiant heating element 11 can also be seen in a cross sectional view.

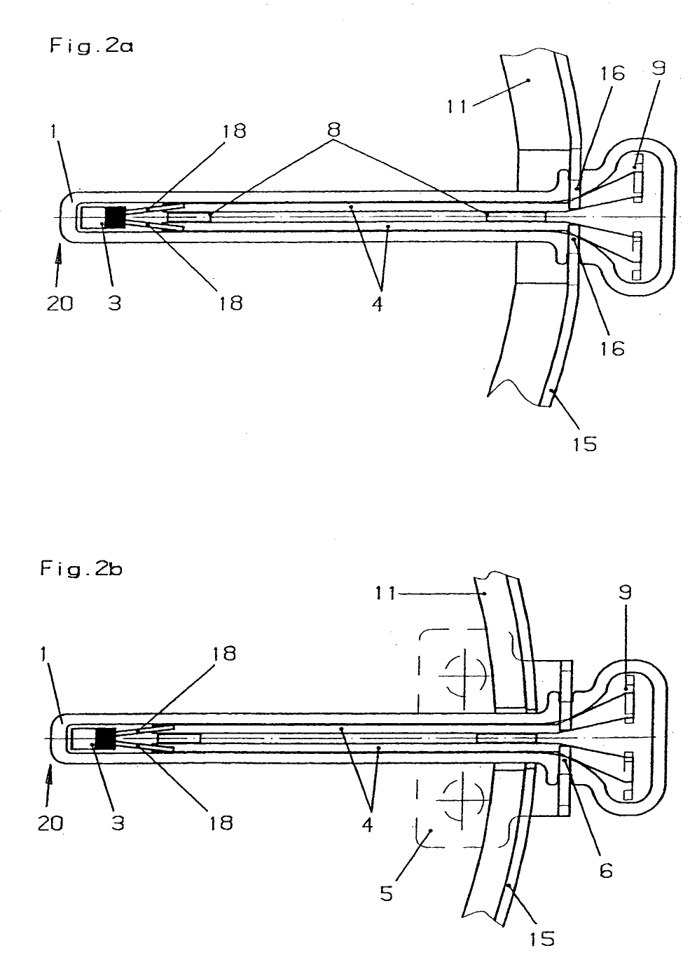

According to FIGS. 2a and 2b the respective trough-shaped ceramic housing 1, optionally closable by means of a cover made of mica, can be seen from above. In the region of its measurement tip or at the end 20 the ceramic housing 1 contains the sensor element 3 for temperature measurement, the sensor element being connected by means of terminal conductors 18 respectively with one of the longitudinally extending pair of electric conductors 4, which are in the rod-shaped part of the protective housing 1.

Between the two conductors 4 a central web 8 made of electrically insulating material is provided to separate or insulate the electric conductors 4. On the end opposite the measuring element 3, the longitudinally extending electric conductors 4 transition into the terminal area containing the retaining tabs 12 and the actual terminal contact 2, which can be seen in FIG. 5. Further, the radiant heating element 11, shown partially cut off, can be seen in FIG. 2a, which is located in a metal pan 15, only a portion of which is shown here, and which fastens the protective housing 1 of the sensor using lugs 16.

In addition FIG. 2b shows the metal flange 5, already described in connection with FIG. 1b, here indicated partially with dashed lines, for the stable support of the ceramic protective housing 1 which, after installing a cover (not seen here) onto the ceramic protective housing 1, is stuck out on the metal flange 5 and is secured in its position by rotating two metal lugs 6. The conductors and contacts are made of a temperature-resistant material, such as stainless steel or Inconel™. Optionally, the sensor element 3 is cemented into the measurement tip end using the already described ceramic grout 10, or a cover 7 made of a mica plate is inserted into the ceramic housing so that the entire internal structure is covered.

FIG. 3a shows a cross section through the ceramic protective housing 1 according to FIGS. 1a and 2a with the electric conductors 4 contained in it, wherein a broken-away portion of the heating element housing 15 can be seen in the background with metal lugs 16 located on its upper edge. The metal lugs serve in this embodiment to fasten the sensor element. Reference number 17 indicates the grout or adhesive for the cover, as already explained in FIG. 1a.

FIG. 3b likewise illustrates a cross section through the ceramic protective housing 1, wherein the metal flange 5 already described in FIGS. 1b and 2b can be seen in the background. However, it is now the upper edge of the flange that is provided with the metal lugs 6. In this embodiment, as well, the metal lugs serve to fasten the sensor.

FIG. 4a shows in a side view the terminal contacts 2 already found in FIG. 1a, wherein the terminal contacts are bent downward along a bend line 9 and serve for connection to a temperature control circuit. A broken away portion of the heating element housing 15 is shown. The retaining tabs 12 are intended to prevent the contacts from sliding upon construction of the sensor arrangement.

FIG. 4b shows an arrangement similar to FIG. 4a. However, this embodiment is used in a device with a metal flange 5 according to FIGS. 1b, 2b, and 3b. Here, as well, the downwardly bent terminal contacts 2 can be seen, wherein the metal lugs 6 are located on the upper edge of the metal flange 5.

According to FIG. 5 one of the two conductors 4 leading to the sensor element (not shown here) is illustrated in a top view, wherein the terminal contact 2 is intended to be bent downwardly along the bend line 9. The respectively laterally projecting, tongue-shaped retaining tabs 12 are designed to prevent the contacts from sliding through upon installation. The conductor 4 is either connected as shown with retaining tabs 12 and terminal contact 2, or a separate part is conceivable, which must be welded on. Conductors 4 can also be formed as a component of the sensor element. In this case, however, the terminal conductors would be omitted.

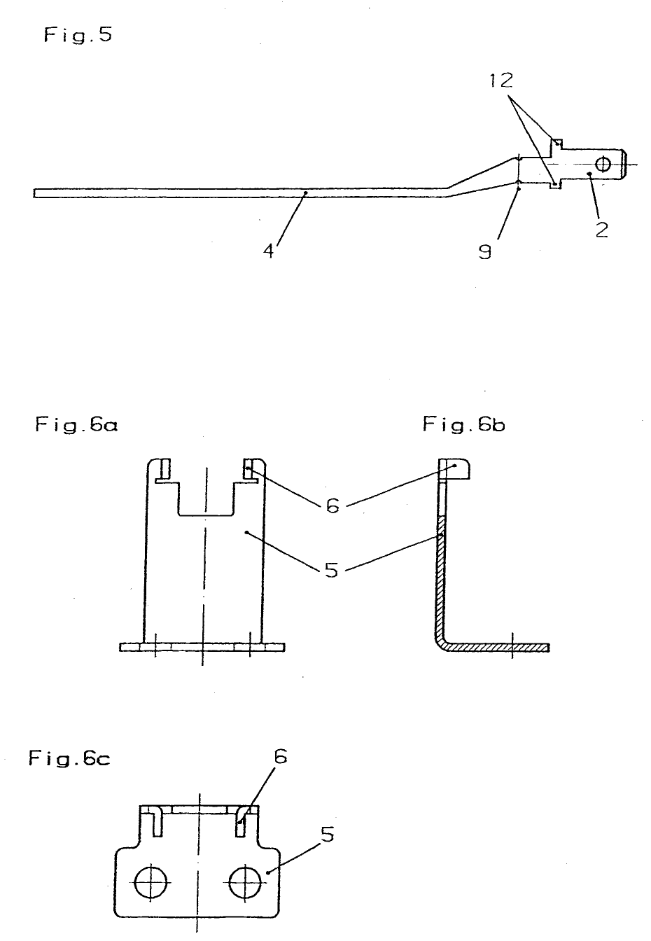

According to the following FIGS. 6a, 6b, and 6c, the metal lugs 6 also secure the optionally placed cover by extending out over the mica cover. The configuration of the metal flange 5 can be varied depending on its use. Using a suitable flange, the sensor and the ceramic protective housing can even be used for other high temperature measurements ranging up to 750° C. The flange 5 shown is, for example, fastened to the base of the radiant heating element 11 using two screws (FIG. 1b).

However, it is also possible to omit the separate flange and to place the ceramic housing directly into an appropriately formed notch made in the metal pan or the radiant heating element housing 15 and, analogously the case of the metal flange 5, to fasten it there using lugs 16. In such a case, the optional cover in the protective housing is cemented using ceramic grout, so that it does not get lost prior to installation in the radiant heating element housing.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A temperature sensor comprising at least one sensor element (3) with electrical connection lines (4), the sensor element and connection lines being at least partially enclosed by a protective housing (1) made of heat-resistant ceramic, the sensor element being arranged in one end region (20) of the protective housing, while the connection lines are guided out through an opposite end of the protective housing, wherein the sensor element (3) comprises a temperature-dependent electrical measuring resistor having a resistive layer with at least one metal from the platinum metal group.

2. The temperature sensor according to claim 1, wherein the heat-resistant ceramic of the protective housing (1) comprises corderite.

3. The temperature sensor according to claim 1, wherein the heat resistant ceramic of the protective housing (1) comprises steatite.

4. The temperature sensor according to claim 1, wherein the protective housing (1) is provided at the opposite end from the sensor element (3) with a connection block to connect the electrical connection lines (4) with terminal contacts.

5. The temperature sensor according to claim 4, wherein the electrical connection lines (4) in an area of the connection block are formed as plug contacts.

6. The temperature sensor according to claim 1, wherein the sensor element (3) is fixed in the end region (20) of the protective housing (1) using a ceramic grout (10).

7. The temperature sensor according to claim 1, wherein the end region (20) of the protective housing is capped using a housing cover (7).

8. The temperature sensor according to claim 1, wherein the protective housing (1) is elongated and constructed as open facing upwardly.

9. The temperature sensor according to claim 8, wherein the protective housing (1) is capped by a cover.

10. The temperature sensor according to claim 1, wherein the sensor element (3) forms a control parameter in a control circuit having at least one radiant heating element acting thermally on the temperature sensor.

11. The temperature sensor according to claim 10, wherein the sensor element acts as a resistance thermometer in a region between a radiant heating element and a hot plate.

12. The temperature sensor according to claim 11, wherein the hot plate is a glass-ceramic hot plate of an electric range.
